(19) United States
(12) Patent Application Publication
(10) Pub. No.: US 2010/0136182 A1
(43) Pub. Date: Jun. 3, 2010

(54) FAT FILLING OR CHOCOLATE SUBSTITUTE FOR CEREAL-BASED BAKERY PRODUCTS

(75) Inventors: Jean-Luc Rabault, Ponthevrard (FR); Francois Belouin, Cerny (FR)

Correspondence Address: PATZIK, FRANK & SAMOTNY LTD., 150 SOUTH WACKER DRIVE, SUITE 1500, CHICAGO, IL, 60606, US

(73) Assignee: Compagnie Gervais Danone, Paris (FR)

(21) Appl. No.: 12/063,280

(22) PCT Filed: Aug. 7, 2006
(86) PCT No.: PCT/FR06/01918

§ 371 Date: Aug. 5, 2008

(30) Foreign Application Priority Data
Aug. 10, 2005 (FR) 0508499

(51) Int. Cl. A23G 1/30; A23D 7/005; A23G 1/54

(52) U.S. Cl. 426/94; 426/601; 426/578; 426/613

(57) ABSTRACT

The invention relates to a butterfat filling or imitation chocolate with a reduced butterfat and/or sugar content, and cereal cooking products comprising one such butterfat filling or imitation chocolate. The inventive butterfat filling or imitation chocolate consists of a suspension of solid particles in a continuous fat phase, said suspension comprising less than 33% butterfat and between 3 and 40% raw starch.

The present invention relates to a fat filling or chocolate substitute with a reduced edible fat and/or reduced sugar content, in particular for cereal-based bakery products, as well as cereal-based bakery products comprising such a fat filling and/or chocolate substitute. Within the meaning of the invention the cereal-based bakery products also include the cereal bars and their Equilibrium Relative Humidity (ERH) is less than 80%.

Reducing the content of edible fats (EF) and sugars in food products, while preserving their organoleptic properties and their texture, is a major challenge for the agri-food industry. In particular in the field of dry biscuits with a fat filling, reducing the edible fat and sugar content is proving difficult. However, such a reduction is very desirable in the fight against obesity.

Fat fillings for dry biscuits contain edible fat in order to control texture and spreadability (shaping in the factory). The edible fat allows the filling to adhere to the biscuit and it gives the filling a melt-in-the-mouth quality. Once it has melted in the mouth, the edible fat ensures a good fluidity and avoids too pasty a product. The standard edible fat content is 31% to 40% EF, typically 33% to 37% EF. When the edible fat content is reduced, the fillings become harder and adhere less easily to the biscuit; in the mouth, the filled biscuit is then less melting and more pasty.

A standard chocolate-flavoured filling typically contains approximately 35% by weight edible fats, approximately 12% by weight defatted cocoa powder, the remainder of the formulation being constituted by saccharose. A simple vanilla-flavoured filling conventionally contains approximately 35% by weight edible fats, approximately 65% by weight saccharose and vanillin.

The sugar content of these fillings is conventionally 49% to 65%. It is known to replace the saccharose by other mono- or disaccharides in order to reduce the price or adjust the sweet flavouring, such as dextrose, lactose or lactoserum (which contains approximately 75% lactose). However, such a substitution does not truly improve the nutritional aspect of the filling.

Other saccharose substitutes which have a good sweet taste and which melt in the mouth are the polyols. However, polyols have the drawback of being expensive, laxative and of being food additives.

Other saccharose substitutes are also known which have no marked sweet taste. These are for example polydextrose (which is expensive and which is also a food additive), or certain low-DE glucose syrups and the maltodextrins (which however contain a certain proportion of mono- and disaccharides and which are rapidly digestible, and which are also fairly sticky in the mouth).

In the case of chocolates or chocolate substitute, the question of reducing the edible fat content and/or sugar content arises in the same way as for fat fillings.

Usually, a reduction in the edible fat content is linked to an increase in the sugar content and conversely, a reduction in sugars is generally linked to an increase in the edible fat content. Such reductions clearly do not improve the nutritional balance of the product concerned.

A purpose of the present invention is therefore to overcome all or some of the drawbacks of the prior art.

To this end, the present invention proposes a fat filling or chocolate substitute, in particular for cereal-based bakery products, constituted by a suspension of solid particles in a continuous fat phase, said suspension comprising less than 33% fats (EF) and 3% to 40% of at least one native and/or overdried starch, these percentages being expressed as weight for weight.

The fat filling according to the invention can be a sweet filling, such as a chocolate, vanilla, milk, caramel, coffee, hazelnut, mint or fruit-flavoured filling or a savoury filling, such as cheese, meat, fish, spices, vegetables.

A chocolate substitute within the meaning of the present invention has a texture which is identical and a taste which is very similar or virtually identical to those of a conventional chocolate. However, unlike the latter, it can contain other ingredients which according to Community Directive 2000/36/EC are not allowed in a chocolate. For example, the edible fats used can be mainly vegetable fats other than cocoa butter. The chocolate substitutes can be milk, dark or white chocolate substitutes. It goes without saying that flavouring and/or colouring ingredients such as for example nut, hazelnut, and strawberry-type dried fruits, or caramel can be added to these chocolate substitutes.

The term “cereal-based bakery product” as used in the present application comprises dry biscuits, wafers, rusks and cereal bars.

Within the meaning of the present Application, the term “sugars” in the plural denotes the mono- and disaccharides introduced alone or via ingredients containing them (skimmed milk powder provides for example 52% lactose).

In the fat fillings or chocolate substitutes according to the present invention, the particle size (defined by the D90 with the Malvern Mastersizer 2000 laser particle size analyzer, i.e. the diameter below which 90% of the volume of all the particles is found) is comprised between 20 μm and 200 μm, preferably between 20 μm and 150 μm, and even more preferably between 35 μm and 120 μm. For a fat filling, the particle size is advantageously comprised between 40 μm and 200 μm, preferably between 70 μm and 150 μm and even more preferably between 70 and 120 μm, for a chocolate substitute between 20 μm and 200 μm, preferably between 20 μm and 80 μm, and even more preferably between 25 μm and 50 μm.

The Applicant has found that it was possible to replace a significant part of the sugars conventionally present in the fat fillings or the chocolate substitutes with native or physically modified starch without affecting the sweet taste of the product. This addition of starch also makes it possible to significantly reduce the edible fat content of the fat fillings or of the chocolate substitutes.

Unlike sugars, starch is not sweet and does not melt in the mouth and it is therefore surprising that the fat fillings and the chocolate substitutes according to the invention, as well as the cereal-based bakery products comprising them have similar or even better organoleptic characteristics than the conventional products.

Any type of starch can be used, and in particular wheat starch, maize starch, waxy maize starch, tapioca starch, rice starch, potato starch, or their mixtures.

Advantageously, native, i.e. uncooked, starch is used. Unlike the glucose syrups, maltodextrins and proteins, native starch absorbs very little saliva in the mouth and therefore does not increase the adherence of the fat filling or the chocolate substitute. Moreover, the native starch being an unmodified natural product, it does not form part of the food additives which must be labelled as such on the packaging of the marketed product.

Moreover, native starch has no digestive drawbacks, unlike the polyols which have a laxative effect, which is particularly undesirable in products which are intended for children. The fact that it is uncooked renders the native starch slowly digestible, which makes it possible to reduce the glycaemic index of the fat filling or the chocolate substitute. Thus the addition of native starch to the fat fillings and chocolate substitutes according to the invention leads, as an additional effect, to a prolonged sensation of satiety compared with standard fat fillings or chocolate substitutes.

Moreover, the density of the native starch is high and its granules do not have a porosity which is accessible to the edible fat. This absence of accessible porosity is important in order to avoid increasing the viscosity of the fat filling or the chocolate substitute following an inclusion of edible fat in the pores.

The particle size of the native starches, which is generally comprised between 2 μm and 100 μm, and more generally between 5 μm and 45 μm, is also ideal for a use in fat fillings or chocolate substitutes. Thus the native starches do not include either too many fine particles, or too many large particles. The presence of fine particles increases the viscosity of the fat filling or of the chocolate substitute and therefore requires an increase in the edible fat content. Conversely, the presence of large particles gives the fat filling or the chocolate substitute a sandy feeling in the mouth. The balance between small-size and large-size particles can be adjusted as necessary in relation to the textures and properties sought, by mixing starches from various sources in different proportions.

In an advantageous embodiment, the particle size of the starch is comprised between 2 μm and 100 μm, preferably between 5 μm and 45 μm, for at least 90% of the particles.

Among the native starches, wheat starch is preferred, because it has an ideal particle size of 2 μm to 45 μm, and because it is a natural constituent of cereal-based bakery products, which are principally based on wheat flour, which is also often mixed with wheat starch.

Maize and manioc starches are also among the preferred starches due to their particle size.

Other advantages of native starch are its neutral taste and its white colour, which allows its use even in products which are not very aromatic, such as vanilla-flavoured fillings or white chocolate substitutes. Finally, the native starch is a cheap ingredient, and it can be used without grinding in the fat fillings and the chocolate substitutes, which allows a simplified process and higher productivity.

Apart from the native starch, according to the invention overdried starches can also be used, i.e. uncooked starches, the humidity content of which has been brought to below their equilibrium relative humidity. It is also possible to envisage the use of a mixture of native starches and overdried starches or different types of overdried starches.

The starch content of a fat filling or of a chocolate substitute according to the invention is 3% to 40%, preferably 3% to 28%, and even more preferably 6% to 25% or also 8 to 18% by weight of starch with respect to the total weight of the fat filling or the chocolate substitute. In a sweet fat filling or a sweet chocolate substitute, 3% to 40% is used, preferably 3 to 35%, advantageously 3% to 25%, preferably 6 to 25% and even more preferably 8 to 18% by weight of starch with respect to the total weight of the fat filling or the chocolate substitute. Savoury fillings contain advantageously 10% to 40%, preferably 15 to 40%, preferably 15 to 30%, and more preferably 20% to 30% by weight of starch with respect to the total weight of the fat filling.

In certain fat fillings or chocolate substitutes according to the invention, all or part of the starch can be incorporated in the form of uncooked native flour rich in starch, for example a cereal flour such as wheat, rice, maize flour. The wheat flour can be incorporated into a mixture of 12% by weight of proteins, 83% of starch with 13% water, 1% of edible fat and 4% of fibre.

In an advantageous embodiment, 3% to 30%, preferably 3% to 20%, more preferably 5% to 17% and more advantageously to 13% by weight of uncooked flour is added with respect to the total weight of the fat filling or the chocolate substitute. Optionally, this flour can be overdried and/or it can be heat-treated (to reduce its microbial load). By a heat-treated flour is meant a flour which has been subjected to a heat treatment to reduce its microbial load, without gelatinizing its starch. Preferably, these uncooked flours are cereal flours.

In another embodiment, the fat filling or chocolate substitute is constituted by a suspension of solid particles in a continuous fat phase, said suspension comprising less than 33% of edible fats (EF) and 3% to 30%, preferably 3% to 20%, more preferably 5% to 17% and more advantageously 8% to 13% by weight with respect to the total weight of the fat filling or the chocolate substitute of a flour, preferably cereal, uncooked, optionally overdried and/or heat-treated.

Starch alone is however the preferred version as regards the version containing of the flour alone or flour and starch, as this produces products which are a little less sticky in the mouth and a little more neutral in taste.

It was not obvious that it would be possible to use a non-overdried starch (or flour), since starch contains water, generally 13% to 20%, which means that the incorporation into a formulation of 15% of wheat starch for example (containing 13% water) contributes approximately 2% water to the formulation. Now, it is well known that the addition of such a quantity of water directly in the free form, or in the form of a honey or a sugar syrup for example, causes the “solidification” of the filling or the chocolate substitute, involves risks of saponification in the presence of lauric EFs in particular (very often used in fat fillings), and consequently the softening of the biscuit which loses of its crunch. Surprisingly and unexpectedly, none of these problems was encountered during the use according to the invention of a starch or a flour in the fat fillings or the chocolate substitutes.

As indicated previously, the addition of starch to the fat filling or the chocolate substitute according to the invention moreover makes it possible to reduce the sugar and edible fat content of these products.

Generally the fat filling or the chocolate substitute contains less than 33% of EF, preferably less than 30%

EF. Also more advantageously, the edible fat content is 20% to 30% EF, preferably 24 to 30%, advantageously 24% to 29% EF, even more preferably from the nutritional point of view, 24 to 27% EF, or even more preferably from the organoleptic point of view, 27% to 29% EF.

Suitable edible fats are the vegetable oils and more particularly the palm oil and lauric fats, rapeseed oil or their mixtures; these oils can be native or at least partially hydrogenated. Among the lauric fats, coconut oil and palm kernel oil can be mentioned. In the chocolate substitutes, totally hydrogenated coconut oil, hydrogenated and fractionated palm kernel oil, hydrogenated and fractionated palm or soya oil are used for example. In the case of the fat fillings, a partially or totally hydrogenated lauric fat, a mixture of hydrogenated lauric fats and native palm oil, or also rapeseed oil is used for example, alone or in a mixture with the above mentioned oils. Cocoa butter could also be mentioned, although financially this is not a worthwhile choice and technically it is not compatible with just any other EF. In short, the edible fats well known to a person skilled in the art are used.

The nature of the edible fat or fats used affects in particular the hardness, the melting sensation in the mouth and the melting point of the filling or the chocolate substitute.

The sugar content, preferably as saccharose, of the fat fillings or the chocolate substitutes according to the invention is advantageously 0 to 55%, preferably 0 to 49%, and even more preferably 10 to 49% by weight with respect to the total weight of the filling or the chocolate substitute. In the case of savoury fillings the sugar content is generally 0% to 55%, preferably 0 to 35%, and even more preferably 5 to 35%, and even 5 to 25% and more particularly 10 to 15% by weight with respect to the total weight of the filling. The sweet fillings and the chocolate substitutes according to the invention comprise preferably 0 to 55%, and even more preferably 0 to 49%, and even more preferably 20 to 49%, and even 30 to 49% and more particularly of 35 to 45% by weight with respect to the total weight of the filling or the chocolate substitute.

For the low-sugar sweet fillings and the chocolate substitutes according to the invention which are intended for adults, the sugar content is 0 to 40%, preferably 10 to 40%, more particularly 20 to 40% and even 25 to 35%.

Fat fillings or chocolate substitutes according to the invention can even be envisaged which are totally sugar-free, where it is possible to use sweeteners such as polyols, intense sweeteners or their mixtures to provide the sugary taste.

The fat fillings or chocolate substitutes according to the invention can comprise ingredients other than edible fats, sugars and starch. These ingredients are ingredients in dried form and comprise in particular emulsifiers, salt, flavourings, milk and milk derivatives, the different forms of cocoa (preferably defatted cocoa powder), caramel, malt, other fillings, such as nuts or other crushed dried fruits, dietary fibre, sugar substitutes and yeasts or their extracts.

Advantageously, these fat fillings or chocolate substitutes comprise one or more emulsifiers, in particular lecithin, ammonium phosphatide, polyglycerol polyricinoleate (PGPR) or their mixtures.

The flavourings can be natural or synthetic flavourings. Among the natural flavourings, vanilla, caramel, cinnamon can be mentioned, and among the synthetic flavourings, vanillin.

The fat fillings and chocolate substitutes according to the invention can be obtained according to standard production processes for these types of products, which are well known to a person skilled in the art. The fat fillings can be slightly aerated during production in order to obtain a density of 800 g/l to 1250 g/l, preferably 1000 g/l to 1200 g/l. A non-aerated fat filling has a density of approximately 1300 g/l.

The present invention also relates to a dry cereal-based bakery product comprising a fat filling and/or a chocolate substitute as described above.

The cereal-based bakery product according to the invention can for example be a biscuit comprising at least one layer of fat filling or chocolate substitute between two layers of dry biscuit.

It can also be a filled wafer, in which at least two leaves of wafer are separated by a layer of fat filling. Preferably, the filled wafer comprises 2 to 4 wafer leaves separated from each other by a layer of fat filling.

The cereal-based bakery product according to the invention can also comprise a chocolate substitute topping, or a moulded piece of chocolate substitute on at least one of its surfaces. The moulded piece of chocolate substitute can for example be interposed between two layers of dry biscuits or wafers.

In one embodiment the cereal-based bakery product comprises a fat filling and a chocolate substitute topping.

Finally, the cereal-based bakery product according to the invention can also comprise a fat filling or a chocolate substitute placed in a hollow biscuit, for example a tartlet or pastry boat. Optionally, the hollow biscuit can be filled first with a fat filling then with a chocolate substitute.

Generally, the cereal-based bakery product according to the invention comprises 20% to 50%, advantageously 20% to 40%, preferably 25% to 35%, and even more preferably either 25% to 30% for an additional nutritional benefit or 28 to 35% for an additional organoleptic benefit, by weight of filling and/or chocolate substitute with respect to the total weight of the finished product.

The cereal-based bakery product according to the invention advantageously comprises 13% to 25% by weight edible fats with respect to the total weight of the cereal-based bakery product, preferably 13 to 21%, even more preferably 15 to 19% and even 15 to 17%.

After sealed packaging, the cereal-based bakery products according to the invention keep for at least 6 months at 22° C.

The following examples of implementation illustrate the present invention without limiting its scope in any way.

### EXAMPLE 1

### Chocolate-Flavoured Fat Fillings

Seven chocolate-flavoured fat fillings are prepared, including a control filling which corresponds to a standard filling without starch, and six fillings A, B1, B2, C1, C2 and D according to the invention. The respective compositions of these fillings are indicated in Table 1 below.

The fillings are produced by simple mixing, for approximately six minutes at 35° C., of all the ingredients in a planetary mixer until a homogeneous paste is obtained. The density is 1180 g/l.

TABLE 1

| | Control | | Filling | Filling | Filling | Filling | |
|---|---|---|---|---|---|---|---|
| Composition | filling | Filling A | B1 | B2 | C1 | C2 | Filling D |
| Icing sugar | 52 | 38.5 | 43.5 | 43.5 | 48.1 | 48.1 | 46.7 |
| Palm oil | 17.5 | 13 | 13.5 | 13.5 | 13.3 | 13.3 | 13 |
| Fully | 17.5 | 13 | 13.5 | 13.5 | 13.3 | 13.3 | 13 |
| hydrogenated | | | | | | | |
| coconut oil | | | | | | | |
| Cocoa powder | 13 | 13 | 13 | 13 | 15 | 15 | 20 |
| (10-12% EF) | | | | | | | |
| Wheat flour | 0 | 6 | 0 | 0 | 3 | 3 | 0 |
| Wheat starch | 0 | 16 | 16 | 0 | 7 | 0 | 7 |
| (13% water) | | | | | | | |
| Maize starch | 0 | 0 | 0 | 16 | 0 | 0 | 0 |
| (13% water) | | | | | | | |
| Overdried | 0 | 0 | 0 | 0 | 0 | 7 | 0 |
| wheat starch | | | | | | | |
| (5% water) | | | | | | | |
| Lecithin | 0 | 0.3 | 0.3 | 0.3 | 0.3 | 0.3 | 0.3 |
| PGPR | 0 | 0.2 | 0.2 | 0.2 | 0 | 0 | 0 |
| Total | 100 | 100 | 100 | 100 | 100 | 100 | 100 |
| % edible | 36.4 | 28 | 28.9 | 28.9 | 28.6 | 28.6 | 28.5 |
| fat by | | | | | | | |
| weight | | | | | | | |
| % sugars by | 52.1 | 38.6 | 43.6 | 43.6 | 48.2 | 48.2 | 46.8 |
| weight | | | | | | | |

The edible fat content as well as the sugar content of fillings A, B1, B2, C1, C2 and D according to the invention is substantially reduced with respect to the control filling.

In spite of the reduction in sugars and in edible fat, the fillings A, B1, B2, C1, C2 and D according to the invention have a sweet taste that is slightly less pronounced, but quite close to that of the control filling. Furthermore, the chocolate taste remains very close to the standard (except for D, which intentionally has a significantly higher cocoa content), as well as the mouthfeel (hardness, melting sensation in the mouth, particle size, pasty consistency).

### EXAMPLE 2

### Chocolate-Flavoured Filled Biscuits

Round biscuits are cooked after rolling and cutting out of the uncooked dough and cooled to 25° C. according to a standard process. These biscuits known to a person skilled in the art (“snack” type biscuits) include 10% fats (palm oil), 18.4% sugars (mono- and disaccharides, of which 16.9% saccharose) 59% starch, 6.9% proteins, 3% fibre and 1.5% water.

7 batches of filled biscuits are prepared with these biscuits, corresponding to standard, chocolate-flavoured biscuits, including one batch of control biscuits comprising the control filling of Example 1, and six batches of filled biscuits A, B1, B2, C1, C2 and D according to the invention comprising respectively the filling A, B1, B2, C1, C2 or D of Example 1.

For each batch of biscuits, the respective filling of Example 1 is placed between 2 round biscuits at a temperature of 30 to 40° C. with a Sogem™ depositing and sandwiching machine, then is cooled down to 20° C. in a cooling tunnel or statically. The fat filling thus crystallized adheres to the 2 biscuits.

The respective compositions of the seven batches of biscuits are shown in Table 2 below.

TABLE 2

| | | Bis- | Bis- | | | | |
|---|---|---|---|---|---|---|---|
| Com- | Control | cuit | cuit | Biscuit | Biscuit | Biscuit | Biscuit |
| position | biscuit | A | B1 | B2 | C1 | C2 | D |
| % fat | 35 | 35 | 32 | 32 | 28 | 28 | 35 |
| filling by | | | | | | | |
| weight | | | | | | | |
| % biscuit | 65 | 65 | 68 | 68 | 72 | 72 | 65 |
| % edible | 19.3 | 16.3 | 16.1 | 16.1 | 15.3 | 15.3 | 16.5 |
| fat by | | | | | | | |
| weight | | | | | | | |
| % sugars | 30.2 | 25.4 | 26.4 | 26.4 | 26.7 | 26.7 | 28.3 |
| by | | | | | | | |
| weight | | | | | | | |
| % dry | 39 | 45.4 | 45.2 | 45.2 | 45.4 | 45.4 | 41.5 |
| starch by | | | | | | | |
| weight | | | | | | | |
| % lipid | 36.7 | 32.4 | 31.9 | 31.9 | 30.5 | 30.5 | 32.8 |
| calories | | | | | | | |

The filled biscuits A, B1, B2, C1, C2 or D according to the invention have an appearance strictly identical to the control, the taste of the biscuit and the crunchy texture of the biscuit being unchanged. The tests are perceived as being very close to the control in terms of smell, sweetness, hardness of the filling. The melting sensation in the mouth, the particle size and the pasty consistency are very close and were not perceived as significantly different by a panel of consumers. The overall preference is not significantly different.

After sealed packaging, the filled biscuits according to the invention keep for at least for 6 months at 22° C.

### EXAMPLE 3

### Chocolate Substitutes

Two chocolate substitutes are prepared, including a chocolate substitute control which corresponds to a standard chocolate substitute without starch, and a chocolate substitute according to the invention. The respective compositions of these chocolate substitutes are indicated in Table 3 below.

The chocolate substitutes are produced by a standard chocolate production process (pre-milling between 2 cylinders, then milling between 5 cylinders and conching for 6 hours at 60° C. However, the starch is added directly at the conching stage, as it does not require grinding.

TABLE 3

| | | Chocolate substitute |
|---|---|---|
| | Chocolate substitute | according to the |
| Composition | Control | invention |
| Icing sugar | 41.9 | 44.45 |
| Lactose monohydrate | 10 | 0 |
| Hydrogenated and | 34 | 26.3 |
| fractionated palm | | |
| kernel oil | | |
| Cocoa powder (10-12% | 13 | 13 |
| EF) | | |
| Wheat starch (13% | 0 | 15 |
| water) | | |
| Lecithin | 0.3 | 0.3 |
| PGPR | 0 | 0.15 |
| E492 | 0.8 | 0.8 |
| Total | 100 | 100 |
| % edible fats by | 36.5 | 29.0 |
| weight | | |
| % sugars by weight | 51.5 | 44.5 |

The edible fat content of the chocolate substitute according to the invention is reduced by 20% in relation to the chocolate substitute control, the sugar content is reduced by 14%.

However, the texture (crunchy then melting in the mouth; particle size) is only slightly affected; the perception of sweetness remains almost equivalent to that of the chocolate substitute control. The product is perceived as having a slightly more cocoa taste and being slightly more bitter.

### EXAMPLE 4

### Coated Biscuits

Round biscuits are cooked after rolling and cutting out the uncooked dough and cooled to 25° C. according to a standard process. These biscuits known to a person skilled in the art include 10% fats (palm oil), 18.4% sugars (mono- and disaccharides, including 16.9% saccharose), 59% starch, 6.9% proteins, 3% fibres and 1.5% water.

2 batches of coated biscuits are prepared with these biscuits, including one batch of control biscuits, comprising a coating of the chocolate substitute control of Example 3, which corresponds to standard chocolate-flavoured coated biscuits and a batch of biscuits comprising a coating of the chocolate substitute according to the invention in Example 3.

The respective compositions of the two batches of biscuits are indicated in Table 4 below.

TABLE 4

| | | Chocolate substitute |
|---|---|---|
| | Chocolate substitute | according to the |
| Composition | control | invention |
| % chocolate | 30 | 30 |
| substitute by weight | | |
| % biscuit | 70 | 70 |
| % edible fats by | 18.0 | 15.7 |
| weight | | |
| % sugars by weight | 28.3 | 26.2 |
| % dry starch by | 41.8 | 45.8 |
| weight | | |
| % lipid calories | 34.7 | 31.3 |

The biscuits coated with the chocolate substitute according to the invention have an appearance strictly identical to the control, the taste of the biscuit and the overall crunchy texture are unchanged. The tests are perceived as very close to the control in terms of smell, sweetness, chocolate taste and melting sensation in the mouth; the particle size and the pasty consistency are equivalent.

After sealed packaging, the coated biscuits according to the invention keep for at least 6 months at 22° C.

1. Fat filling or chocolate substitute constituted by a suspension of solid particles in a continuous fat phase, said suspension comprising less than 33% edible fats (EF) and 3% to 40% of at least one native and/or overdried starch, these percentages being expressed as weight for weight.

2. Fat filling or chocolate substitute constituted by a suspension of solid particles in a continuous fat phase, said suspension comprising less than 33% edible fats (EF) and 3% to 30% by weight with respect to the total weight of the fat filling or of the chocolate substitute of a flour, preferably cereal, uncooked, optionally overdried and/or heat-treated.

3. Fat filling or chocolate substitute according to claim 1 or 2, wherein the starch is selected from the group consisting of a wheat starch, maize starch, waxy maize starch, tapioca starch, rice starch, potato starch, and their mixtures.

4. Fat filling or chocolate substitute according to claim 3, wherein the starch is wheat starch.

5. Fat filling or chocolate substitute according to claim 1 or 2, wherein at least 90% of the starch particles have a particle size comprised between 2 μm and 100 μm, preferably between 5 μm and 45 μm.

6. Fat filling or chocolate substitute according to claim 1 or 2, wherein the suspension comprises at least one emulsifier.

7. Fat filling or chocolate substitute according to claim 6, wherein the emulsifier is selected from the group consisting of lecithin, ammonium phosphatide, polyglycerol polyricinoleate (PGPR) and their mixtures.

8. Fat filling or chocolate substitute according to claim 1 or 2, wherein the suspension comprises between 0 and 55% sugars, preferably saccharose, by weight with respect to the total weight of the filling or the chocolate substitute.

9. Fat filling or chocolate substitute according to claim 8, wherein the sugar content of the fat filling or the chocolate substitute is 10 to 49% by weight with respect to the total weight of the filling or the chocolate substitute.

10. Fat filling or chocolate substitute according to claim 1 or 2, wherein the suspension comprises salt.

11. Fat filling or chocolate substitute according to claim 1 or 2, wherein the suspension comprises one or more flavourings.

12. Dry cereal-based bakery product comprising a fat filling and/or a chocolate substitute according to claim 1 or 2.

13. Cereal-based bakery product according to claim 12, wherein it is a biscuit comprising at least one layer of fat filling or chocolate substitute between two layers of dry biscuit.

14. Cereal-based bakery product according to claim 12, wherein it comprises a layer of chocolate substitute on at least one of its surfaces.

15. Cereal-based bakery product according to claim 12, wherein it comprises a fat filling or a chocolate substitute placed in a hollow biscuit, said hollow biscuit being able to be filled firstly with a fat filling then with a chocolate substitute.

16. Cereal-based bakery product according to claim 12, wherein it comprises 20% to 50% by weight filling and/or chocolate substitute with respect to the total weight of the finished product.

17. Cereal-based bakery product according to claim 12, wherein it comprises 13% to 25% by weight edible fats with respect to the total weight of the finished cereal-based bakery product, preferably 13 to 21% , even more preferably 15 to 19% and even 15 to 17%.
